(19) United States
(12) Patent Application Publication
(10) Pub. No.: US 2008/0225970 A1
(43) Pub. Date: Sep. 18, 2008

(54) APPARATUS AND METHOD FOR TRANSMITTING/RECEIVING A SIGNAL IN A MIMO MOBILE COMMUNICATION SYSTEM

(75) Inventors: Dong-Ho KIM, Seoul (KR); In-Soo Hwang, Yongin-si (KR); Yung-Soo Kim, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/049,737

(22) Filed: Mar. 17, 2008

(30) Foreign Application Priority Data
Mar. 16, 2007 (KR) 26228-2007

(51) Int. Cl. H04L 27/28

(52) U.S. Cl. 375/260

(57) ABSTRACT

Disclosed is a method to transmit a signal in a Multiple Input Multiple Output (MIMO) mobile communication system. The method includes determining a Hybrid Automatic Repeat reQuest (HARQ) scheme to be used for a transmission signal; determining a MIMO scheme to be used for the transmission signal in accordance with the determined HARQ scheme; and transmitting the transmission signal using the determined HARQ scheme and the determined MIMO scheme.

### PRIORITY

This application claims the priority under 35 U.S.C. §119(a) to a Korean Patent Application entitled “Apparatus And Method For Transmitting/Receiving A Signal In A MIMO Mobile Communication System” filed in the Korean Industrial Property Office on Mar. 16, 2007 and assigned Serial No. 2007-26228, the contents of which are incorporated herein by reference.

### BACKGROUND OF THE INVENTION

1. Field of the Invention

The present invention relates to an apparatus and a method for signal transmission/reception in a mobile communication system, and more particularly to an apparatus and a method for signal transmission/reception in a mobile communication system using a Multiple Input Multiple Output (MIMO) scheme.

2. Description of the Related Art

In general, next-generation communication systems are being developed in pursuit of a system capable of providing a service allowing high-speed large-capacity data transmission/reception to Mobile Stations (MSs). However, in contrast to wired channel environments, wireless channel environments of mobile communication systems undergo inevitable errors, which cause loss of information due to various factors such as multi-path interference, shadowing, electric wave attenuation, time-varying noise, interference, and fading.

The loss of information may cause severe distortion of an actual transmission signal, thereby degrading the entire mobile communication system performance. Therefore, in order to eliminate the instability of communication due to the loss of information, the MIMO scheme and a Hybrid Automatic Repeat reQuest (HARQ) scheme have been proposed. Hereinafter, the MIMO scheme and the HARQ scheme will be described.

First, the MIMO scheme will be described.

The MIMO scheme can be largely classified into an Open Loop (OL) scheme and a Closed Loop (CL) scheme, each of which can be divided into a Spatial Multiplexing (SM) scheme, a Space Time Transmit Diversity (STTD) scheme, and a Double Space Time Transmit Diversity (DSTTD) scheme. Of course, in the MIMO scheme, it is possible to additionally take a Linear Dispersion (LD) scheme into account as well as the SM scheme, the STTD scheme, and the DSTTD scheme. Hereinafter, for convenience, an SM scheme in the OL scheme is referred to as an “OL-SM” scheme, an STTD scheme in the OL scheme is referred to as an “OL-STTD” scheme, a DSTTD scheme in the OL scheme is referred to as an “OL-DSTTD” scheme, an SM scheme in the CL scheme is referred to as an “CL-SM” scheme, an STTD scheme in the CL scheme is referred to as an “CL-STTD” scheme, and a DSTTD scheme in the CL scheme is referred to as an “CL-DSTTD” scheme.

Second, the HARQ scheme will be discussed.

The HARQ scheme has improved reliability due to re-transmission of lost information. Further, the HARQ scheme can be classified into a Chase Combining (CC) scheme and an Incremental Redundancy (IR) scheme. The CC scheme and the IR scheme are discussed below.

First, the CC scheme will be discussed.

According to the CC scheme, the signal transmission apparatus transmits symbols of the same format at the time of initial transmission and re-transmission, and the signal reception apparatus performs maximum ratio combining in order to decode the symbols transmitted at the time of initial transmission and re-transmission.

Second, the IR scheme will be discussed.

According to the IR scheme, the signal transmission apparatus transmits only a part of parity bits included in a parity vector and an information vector at the time of initial transmission according to a Modulation and Coding Scheme (MCS) level corresponding to a Channel Quality Indication (CQI) information between the signal transmission apparatus and a signal reception apparatus. As used herein, the information vector includes at least one information bit and the parity vector includes at least one parity bit. Further, a signal transmitted at the time of initial transmission is called an “IR version 1 signal.” Thereafter, if the signal transmission apparatus receives a notification that the IR version 1 signal has an error from the signal reception apparatus, the signal transmission apparatus transmits some of the parity bits other than the parity bits included in the IR version 1 signal within the parity vector to the signal reception apparatus. As used herein, a signal transmitted at the time of first re-transmission is called an “IR version 2 signal.” Thereafter, if the signal transmission apparatus receives a notification that the IR version 2 signal has an error from the signal reception apparatus, the signal transmission apparatus transmits the information vector and all the remaining parity bits other than the parity bits included in the IR version 1 signal and the IR version 2 signal within the parity vector to the signal reception apparatus. As used herein, a signal transmitted at the time of second re-transmission is called an “IR version 3 signal.” Thereafter, if the signal transmission apparatus receives a notification that the IR version 3 signal has an error from the signal reception apparatus, the signal transmission apparatus transmits a signal including both the information vector and the parity vector to the signal reception apparatus. As used herein, a signal transmitted at the time of third re-transmission is called an “IR version 4 signal,” and each of the signals transmitted by the signal transmission apparatus after the third re-transmission is identical to the IR version 4 signal. That is, even in the case of using the IR scheme, retransmission after a predetermined number of times of retransmission is performed in the same way as that of the CC scheme. The configuration of signals according to the IR versions as described above in relation to the IR scheme is only an example for convenience of description, and it is of course possible to employ a different signal configuration.

As described above, both the MIMO scheme and the HARQ scheme eliminate the instability of communication due to loss of information. Therefore, simultaneous use of both the MIMO scheme and the HARQ scheme can improve the stability of the system. Accordingly, use of the HARQ scheme is being actively taken into consideration in current MIMO mobile communication systems.

However, in the MIMO mobile communication system, once a MIMO scheme to be used is determined, the determined MIMO scheme is used regardless of whether the transmission is an initial transmission or retransmission. For example, if it has been determined to use a CL-SM scheme as a MIMO scheme in the MIMO mobile communication system, the CL-SM scheme is used regardless of initial transmission or retransmission in using the HARQ scheme. Therefore, there is emerging a request for a solution for adaptively controlling use of a MIMO scheme in consideration of the initial transmission and retransmission in the case of using an HARQ scheme in a MIMO mobile communication system.

### SUMMARY OF THE INVENTION

Accordingly, the present invention has been made to solve the above-mentioned problems occurring in the prior art, and the present invention provides an apparatus and a method for adaptively controlling use of a Multiple Input Multiple Output (MIMO) scheme in consideration of the initial transmission and retransmission in the case of using a Hybrid Automatic Repeat request (HARQ) scheme in a MIMO mobile communication system.

In accordance with an aspect of the present invention, there is provided a signal transmission apparatus in a Multiple Input Multiple Output (MIMO) mobile communication system, the signal transmission apparatus including a controller to determine a Hybrid Automatic Repeat reQuest (HARQ) scheme to be used for a transmission signal and determine a MIMO scheme to be used for the transmission signal in accordance with the determined HARQ scheme; an encoder to encode the transmission signal according to the determined HARQ scheme; a mapper to map a signal output from the encoder according to the determined MIMO scheme; and a transmitter to transmit a signal output from the mapper.

In accordance with another aspect of the present invention, there is provided a signal transmission apparatus in a MIMO mobile communication system, the signal transmission apparatus including a controller to determine a packet format to be used for a transmission signal, and transmit the transmission signal using an HARQ scheme and a MIMO scheme determined in accordance with the determined packet format; an encoder to encode the transmission signal according to the determined HARQ scheme; a mapper to map a signal output from the encoder according to the determined MIMO scheme; and a transmitter to transmit a signal output from the mapper.

In accordance with another aspect of the present invention, there is provided a method to transmit a signal by a signal transmission apparatus in a MIMO mobile communication system, the method including determining an HARQ scheme to be used for a transmission signal; determining a MIMO scheme to be used for the transmission signal in accordance with the determined HARQ scheme; and transmitting the transmission signal using the determined HARQ scheme and the determined MIMO scheme.

In accordance with another aspect of the present invention, there is provided a method to transmit a signal by a signal transmission apparatus in a MIMO mobile communication system, the method including determining a packet format to be used for a transmission signal; and transmitting the transmission signal using an HARQ scheme and a MIMO scheme determined in accordance with the determined packet format.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a structure of a signal transmission apparatus of a MIMO mobile communication system using an SCW according to an embodiment of the present invention;

FIG. 2 illustrates a structure of a table reflecting a packet format, the number of times of retransmission, and a MIMO scheme in a MIMO mobile communication system according to an embodiment of the present invention;

FIG. 3 schematically illustrates a process of transmitting a signal by the signal transmission apparatus when PF=4 in the table of FIG. 2;

FIG. 4 schematically illustrates a process of transmitting a signal by the signal transmission apparatus when PF=6 in the table of FIG. 2;

FIG. 5 is a block diagram illustrating a structure of a signal reception apparatus of a MIMO mobile communication system using an SCW according to an embodiment of the present invention;

FIG. 6 is a block diagram illustrating a structure of a signal transmission apparatus of a MIMO mobile communication system using an MCW according to an embodiment of the present invention; and

FIG. 7 is a block diagram illustrating a structure of a signal reception apparatus of a MIMO mobile communication system using an MCW according to an embodiment of the present invention.

### DETAILED DESCRIPTION OF THE EXEMPLARY EMBODIMENT

Hereinafter, exemplary embodiments of the present invention will be described with reference to the accompanying drawings. In the following description, a detailed description of known functions and configurations incorporated herein will be omitted when it may make the subject matter of the present invention rather unclear.

The present invention provides an apparatus and a method for adaptively controlling use of a MIMO scheme in consideration of an initial transmission and retransmission while using an HARQ scheme in a MIMO mobile communication system. The present invention further provides an apparatus and a method for adaptively controlling use of a MIMO scheme in accordance with an IR version of a signal to be transmitted by a signal transmission apparatus in the case of using an IR scheme as an HARQ scheme in a MIMO mobile communication system.

As used herein, it is assumed that the MIMO scheme includes an SM scheme, an STTD scheme, and a DSTTD scheme of an OL scheme, and an SM scheme, an STTD scheme, and a DSTTD scheme of a CL scheme. Of course, as the MIMO scheme, it is possible to additionally take an LD scheme into account as well as the SM scheme, the STTD scheme, and the DSTTD scheme. Hereinafter, for convenience of description, an SM scheme in the OL scheme is referred to as an “OL-SM” scheme, an STTD scheme in the OL scheme is referred to as an “OL-STTD” scheme, a DSTTD scheme in the OL scheme is called an “OL-DSTTD” scheme, an SM scheme in the CL scheme is referred to as an “CL-SM” scheme, an STTD scheme in the CL scheme is referred to as an “CL-STTD” scheme, and a DSTTD scheme in the CL scheme is referred to as an “CL-DSTTD” scheme.

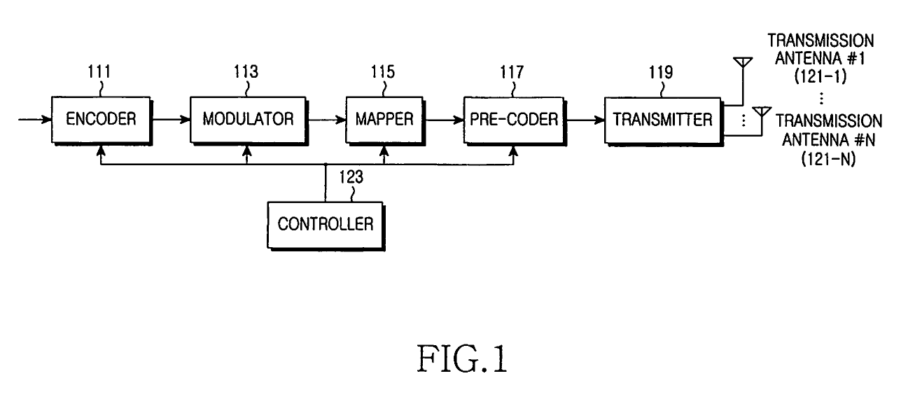

Hereinafter, a structure of a signal transmission apparatus of a MIMO mobile communication system using a Single CodeWord (SCW) according to an embodiment of the present invention will be described with reference to the block diagram of FIG. 1.

Before describing FIG. 1, it is assumed that the signal transmission apparatus uses an IR scheme as the HARQ scheme. As described above in relation to the prior art, the IR scheme applies the same operation principle as the operation principle of the CC scheme at the IR version 4 and thereafter. Hereinafter, for convenience of description, the CC scheme and IR schemes of version 4 or greater will be referred to as a “CC scheme.” Referring to FIG. 1, the signal transmission apparatus includes an encoder 111, a modulator 113, a mapper 115, a pre-coder 117, a transmitter 119, a plurality of antennas including a transmission antenna #1 121-1 to a transmission antenna #N 121-N, wherein N is the number of transmission antennas, and a controller 123.

First, when an information vector to be transmitted is present in the signal transmission apparatus, the information vector is delivered to the encoder 111. The encoder 111 generates a codeword vector by encoding the information vector in accordance with a preset mother code rate, and outputs all or a part of the codeword vector in accordance with the IR version information provided by the controller 123.

Only when the signal transmission apparatus performs an initial transmission, does the encoder 111 generate the codeword vector from the information vector in accordance with the mother code rate. Based on the IR version information, it is possible to determine if the signal transmission apparatus is performing initial transmission or retransmission. That is, when the IR information indicates an IR version 1, the IR information implies that the signal transmission apparatus is performing an initial transmission. Also, when the IR information indicates an IR version 2 or greater, the IR information implies that the signal transmission apparatus is performing a retransmission. In the meantime, regardless of whether the signal transmission apparatus performs initial transmission or retransmission, the encoder 111 outputs all or a part of the codeword vector in accordance with a coding rate provided by the controller 123. A process of controlling an operation of the encoder 111 by the controller 123 will be described later in more detail.

The modulator 113 receives the signal output from the encoder 111, modulates the received signal according to a modulation scheme under the control of the controller 123, and then outputs the modulated signal to the mapper 115. Here, the modulation scheme may be a Binary Phase Shift Keying (BPSK) scheme, a Quadrature Phase Shift Keying (QPSK) scheme, or a 16 Quadrature Amplitude Modulation (16 QAM) scheme. A process of controlling an operation of the modulator 113 by the controller 123 will be described later in more detail.

The mapper 115 receives the signal output from the modulator 113, maps the signal according to a mapping scheme under the control of the controller 123, and outputs the mapped signal to the pre-coder 117. As used herein, the mapping scheme may be an OL-SM scheme, an OL-STTD scheme, an OL-DSTTD scheme, a CL-SM scheme, a CL-STTD scheme, or a CL-DSTTD scheme. A process of controlling an operation of the mapper 115 by the controller 123 will be described later in more detail.

The pre-coder 117 receives the signal output from the mapper 115, pre-codes the signal according to a pre-coding scheme under the control of the controller 123, and outputs the mapped signal to the transmitter 119. As used herein, the pre-coding scheme can be expressed by a pre-coding matrix. A process of controlling an operation of the pre-coder 117 by the controller 123 will be described later in more detail.

The transmitter 119 receives the signal output from the pre-coder 117, processes the received signal according to a preset transmission scheme, such as an Orthogonal Frequency Division Multiplexing (OFDM) scheme, and then transmits the processed signal through transmission antenna #1 121-1 to transmission antenna #N 121-N to a signal reception apparatus.

Hereinafter, an operation of the controller 123 will be described.

Before describing the operation of the controller 123, a relation between the MIMO scheme and the number of times of retransmission will be described.

First, when there are parity bits to be transmitted in a retransmission, such as the first retransmission, in a signal transmission apparatus, it is preferred to obtain a maximum coding gain by transmitting as many parity bits as possible. At this time, the signal transmission apparatus selects the SM scheme rather than the STTD scheme, which is a diversity scheme, as the MIMO scheme, in order to maximize the obtained coding gain by transmitting as many parity bits as possible. That is, it is preferred that the signal transmission apparatus transmits the signals of IR version 1 to IR version 3 according to the SM scheme.

Next, in a retransmission after every parity bit has been transmitted at least one time by the signal transmission apparatus, such as after third retransmission, it is preferred to use a transmission scheme having a high reliability. As used herein, the expression that every parity bit has been transmitted at least one time corresponds to use of the CC scheme as the HARQ scheme. Especially, as the number of times of retransmission increases, the delay time increases. Therefore, it is preferred to use a transmission scheme having a high reliability. At this time, the signal transmission apparatus performs retransmission by selecting the STTD scheme, which is a diversity scheme, rather than the SM scheme, as the MIMO scheme, so as to improve the reliability. That is, it is preferred that the signal transmission apparatus transmits the signals of IR version 4 or greater according to the STTD scheme.

Therefore, the controller 123 determines a mapping scheme to be used by the mapper 115 in accordance with the IR version. That is, the controller 123 determines the mapping scheme of the mapper 115 to be the SM scheme when the IR version is 1 to 3, and determines the mapping scheme of the mapper 115 to be the STTD scheme when the IR version is 4 or above. Here, when the mapper 115 uses the SM scheme or the STTD scheme, the mapper 115 can use either the OL scheme or the CL scheme without any problems. That is, for IR versions 1 to 3 when the mapper 115 uses the OL scheme and determines the mapping scheme to be the CL-SM scheme when the mapper 115 uses the CL scheme, the controller 123 determines the mapping scheme to be the OL-SM scheme. Moreover, in the case of IR version 4 or above, when the mapper 115 uses the OL scheme and determines the mapping scheme to be the CL-STTD scheme when the mapper 115 uses the CL scheme, the controller 123 determines the mapping scheme to be the OL-STTD scheme.

Further, the controller 123 determines an MCS level corresponding to a CQI information between a signal transmission apparatus and a signal reception apparatus of the MIMO mobile communication system. Here, when the mapper 115 uses the CL scheme, the controller 123 determines the MCS level according to the CQI between the signal transmission apparatus and the signal reception apparatus, which is fed back from the signal reception apparatus. By contrast, when the mapper 115 uses the OL scheme, the controller 123 determines the MCS level by itself because the CQI is not fed back from the signal reception apparatus.

Therefore, the controller 123 determines a coding rate to be used by the encoder 111 in accordance with an IR version and the determined MCS level. That is, the controller 123 determines the coding rate and controls the encoder 111 according to the IR version and the MCS level to determine if the encoder 111 should all or a part of the codeword vector.

Further, the controller 123 controls the operation of the pre-coder 117 according to whether the mapper 115 uses the OL scheme or the CL scheme. That is, when the mapper 115 uses the OL scheme, the controller 123 controls the pre-coder 117 to make the pre-coder 117 bypass the signal output from the mapper 115 without performing a separation operation. By contrast, when the mapper 115 uses a CL scheme, the controller 123 generates a pre-coding matrix to be used by the pre-coder 117 in accordance with the CQI fed back from the signal reception apparatus. An operation of generating the pre-coding matrix by the controller 123 has no direct relation to the present invention, so a detailed description thereof is thus omitted here. Further, in the present embodiment of the present invention described above, the controller 123 controls the pre-coder 117 to make the pre-coder 117 bypass the signal output from the mapper 115 without performing a separation operation. However, according to another embodiment of the present invention, the controller 123 may generate an identity matrix as the pre-coding matrix and control the pre-coder 117 in a manner to make the pre-coder 117 pre-code the signal output from the mapper 115 using the identity matrix.

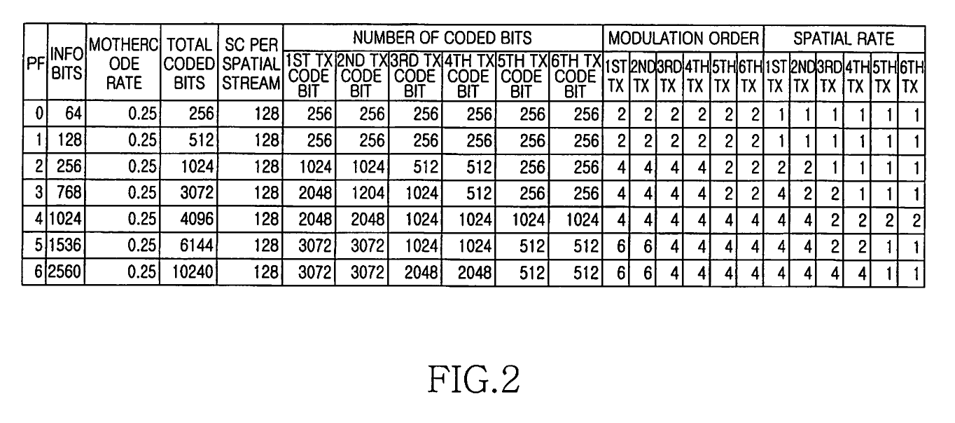

Meanwhile, the controller 123 may control operations of the encoder 111, the modulator 113, and the mapper 115, based on a table taking the MIMO scheme, the number of retransmissions, and the packet format into consideration. Hereinafter, a structure of the table will be described with reference to FIG. 2.

The table shown in FIG. 2 includes parameters as follows:

(1) PF

The term “PF” refers to a packet format index.

(2) info bits

The term “info bits” refers to the number of information bits included in an information vector.

(3) Mother Code Rate

The term “Mother Code Rate” indicates a mother code rate applied to the information vector.

(4) Total coded bits

The “Total coded bits” indicates the number of all bits included in the codeword vector.

(5) SC per spatial stream

The “SC per spatial stream” indicates the number of all bits included in an SCW for each spatial stream, wherein the spatial stream refers to a stream transmitted through one transmission antenna.

(6) Number of coded bits

The “Number of coded bits” indicates the number of bits transmitted at each time of transmission, wherein the “Number of coded bits” determines a coding rate of the transmission.

(7) Modulation Order

The “Modulation Order” indicates a modulation order used at each time of transmission. For example, when the “Modulation Order” is 4, it implies the 16 QAM scheme.

(8) spatial rate

The “spatial rate” indicates the MIMO scheme. For example, a spatial rate of 1 implies the STTD scheme, a spatial rate of 2 implies the D-STTD scheme, and a spatial rate of 4 implies the SM scheme.

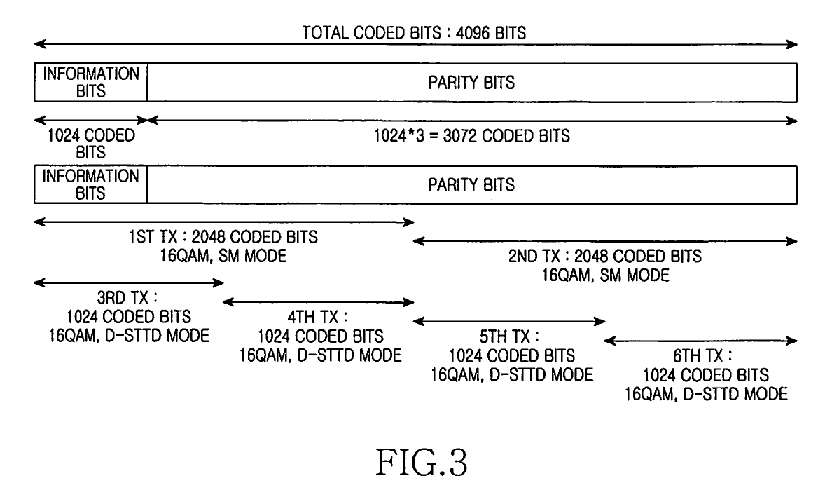

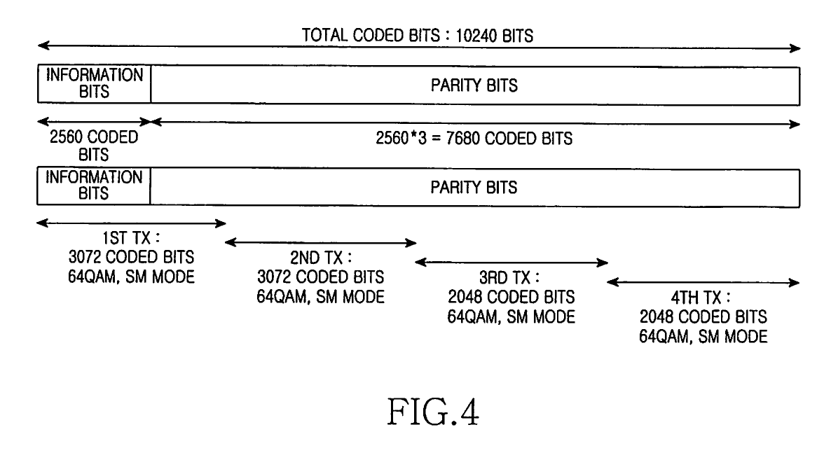

Hereinafter, a process of transmitting a signal in accordance with the table by a signal transmission apparatus will be described with reference to FIGS. 3 and 4.

FIG. 3 schematically illustrates a process of transmitting a signal by the signal transmission apparatus when PF=4 in the table of FIG. 2.

The operation of the signal transmission apparatus shown in FIG. 3 corresponds to a case where PF=4. Once the signal transmission apparatus determines to use a packet format having a PF of 4, as shown in FIG. 3, the controller 123 of the signal transmission apparatus determines a mother coding rate, a coding rate, a modulation scheme, and a MIMO scheme thereof, as shown in FIG. 3.

FIG. 4 schematically illustrates a process of transmitting a signal by the signal transmission apparatus when PF =6 in the table of FIG. 2.

The operation of the signal transmission apparatus shown in FIG. 4 corresponds to a case where PF=6. Once the signal transmission apparatus determines to use a packet format having a PF of 6 (PF=6) as shown in FIG. 4, the controller 123 of the signal transmission apparatus determines a mother coding rate, a coding rate, a modulation scheme, and a MIMO scheme thereof, as shown in FIG. 4.

Meanwhile, although not separately shown in FIG. 1, information on the mother coding rate, the coding rate, the modulation scheme, and the MIMO scheme used by the controller 123 is delivered to a signal reception apparatus corresponding to the signal transmission apparatus through a separate control channel or a separate control message.

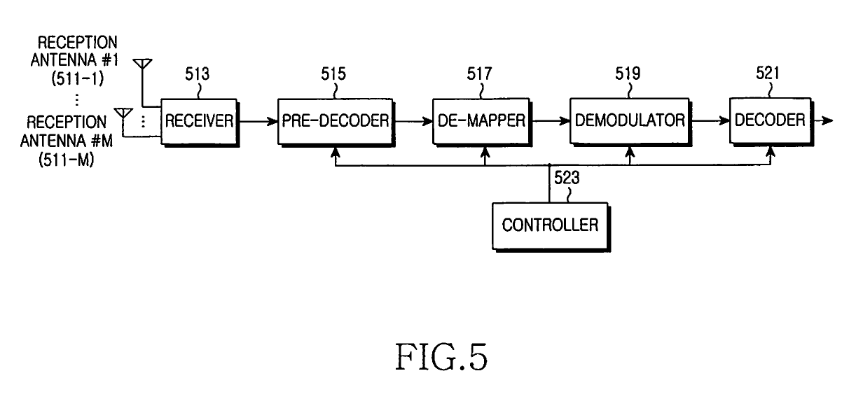

Next, a structure of a signal reception apparatus of a MIMO mobile communication system using an SCW according to an embodiment of the present invention will be described with reference to the block diagram of FIG. 5.

Referring to FIG. 5, the signal reception apparatus includes a plurality of antennas (in this case, for example, a number M reception antennas includes reception antenna #1 511-1 to reception antenna #M 511-M), a receiver 513, a pre-decoder 515, a de-mapper 517, a demodulator 519, a decoder 521, and a controller 523.

First, when signals are received through reception antenna #1 511-1 to reception antenna #M 511-M, the received signals are delivered to the receiver 513. Then, the receiver 513 processes the signals according to a signal reception scheme corresponding to a signal transmission scheme (i.e., an Orthogonal Frequency Division Multiplexing (OFDM) scheme) used by the transmitter 119 of the signal transmission apparatus corresponding to the signal reception apparatus (see FIG. 1), and then outputs the processed signals to the pre-decoder 515. The pre-decoder 515 receives the signals output from the receiver 513, either pre-decodes or bypasses the signals under the control of the controller 523, and then outputs the signals to the de-mapper 517. At this time, when the pre-coder 117 of the signal transmission apparatus uses a pre-coding matrix, the controller 523 controls the pre-decoder 515 to pre-decode the signals output from the receiver 513 using an inverse matrix of the pre-coding matrix used by the pre-coder 117. By contrast, when the pre-coder 117 of the signal transmission apparatus does not use a pre-coding matrix, the controller 523 controls the pre-decoder 515 to make the pre-decoder 515 bypass the signals output from the receiver 513.

Under the control of the controller 523, the de-mapper 517 receives and de-maps the signals output from the pre-decoder 515, and then outputs the de-mapped signals to the demodulator 519. At this time, the controller 523 controls the operation of the de-mapper 517 in accordance with the MIMO scheme used by the mapper 115 of the signal transmission apparatus. Under the control of the controller 523, the demodulator 519 receives the signals output from the de-mapper 517, demodulates the signals, and then outputs the demodulated signals to the decoder 521. At this time, the controller 523 controls the operation of the demodulator 519 in accordance with the modulation scheme used by the modulator 113 of the signal transmission apparatus. Then, under the control of the controller 523, the decoder 521 receives and decodes the signals output from the demodulator 519. At this time, the controller 523 controls the operation of the decoder 521 in accordance with the encoding scheme used by the encoder 111 of the signal transmission apparatus.

Meanwhile, although not separately shown in FIG. 5, the signal reception apparatus receives information on the mother coding rate, the coding rate, the modulation scheme, and the MIMO scheme used by the signal transmission apparatus through a separate control channel or a separate control message from the signal transmission apparatus. Then, the received information on the mother coding rate, the coding rate, the modulation scheme, and the MIMO scheme is delivered to the controller 523. Based on the information on the mother coding rate, the coding rate, the modulation scheme, and the MIMO scheme used by the signal transmission apparatus, the controller 523 controls the operations of the pre-decoder 515, the de-mapper 517, the demodulator 519, and the decoder 521.

Further, although not separately shown in FIG. 5, when the signal transmission apparatus uses the CL scheme as the MIMO scheme, the signal reception apparatus generates a CQI or a pre-coding matrix and then feeds back the generated CQI or pre-coding matrix to the signal transmission apparatus.

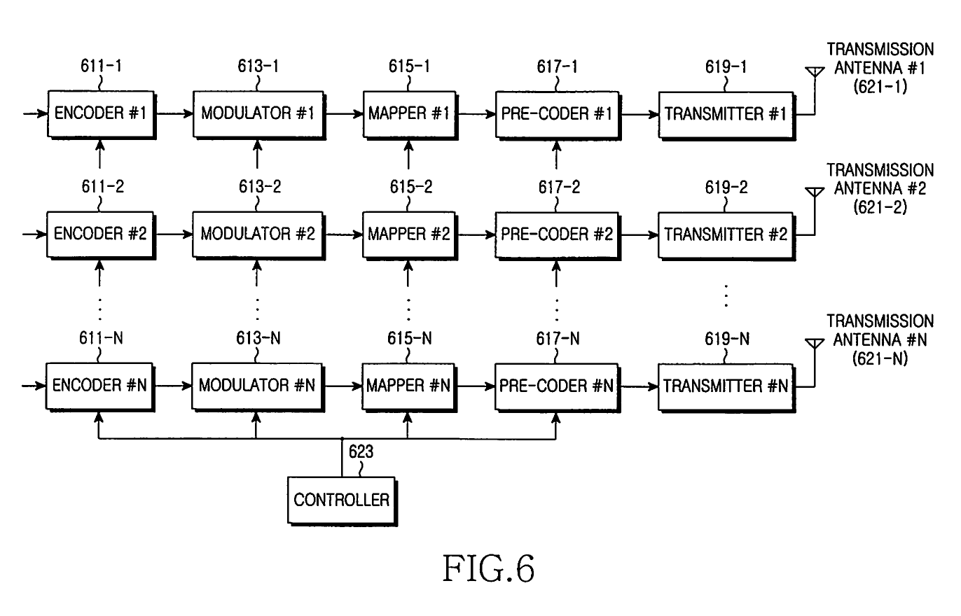

Next, a structure of a signal transmission apparatus of a MIMO mobile communication system using a Multiple CodeWord (MCW) according to an embodiment of the present invention will be described with reference to the block diagram of FIG. 6.

In the description of the signal transmission apparatus below, it is assumed that the signal transmission apparatus uses the IR scheme as the HARQ scheme and uses a total of N codewords.

Referring to FIG. 6, the signal transmission apparatus includes structures for processing the N codewords, respectively, which will be described below.

First, a structure for processing codeword #1, which is the first codeword from among the N codewords, includes encoder #1 611-1, modulator #1 613-1, mapper #1 615-1, pre-coder #1 617-1, transmitter #1 619-1, and transmission antenna #1 621-1. Second, a structure for processing codeword #2, which is the second codeword from among the N codewords, includes encoder #2 611-2, modulator #2 613-2, mapper #2 615-2, pre-coder #2 617-2, transmitter #2 619-2, and transmission antenna #2 621-2. In the same manner, a structure for processing codeword #N, which is the N^{th} codeword from among the N codewords, includes encoder #N 611-N, modulator #N 613-N, mapper #N 615-N, pre-coder #N 617-N, transmitter #N 619-N, and transmission antenna #N 621-N. Further, encoder #1 611-1 to encoder #N 611-N, modulator #1 613-1 to modulator #N 613-N, mapper #1 615-1 to mapper #N 615-N, and pre-coder #1 617-1 to pre-coder #N 617-N operate under the control of the controller 623.

The signal transmission apparatus shown in FIG. 6 is different from the signal transmission apparatus using an SCW shown in FIG. 1 only in that the signal transmission apparatus of FIG. 6 processes N codewords. However, a basic control operation of the signal transmission apparatus, i.e., a control operation of the controller 623, is similar to the control operation of the controller 123 illustrated in FIG. 1, so a detailed description thereof is omitted here.

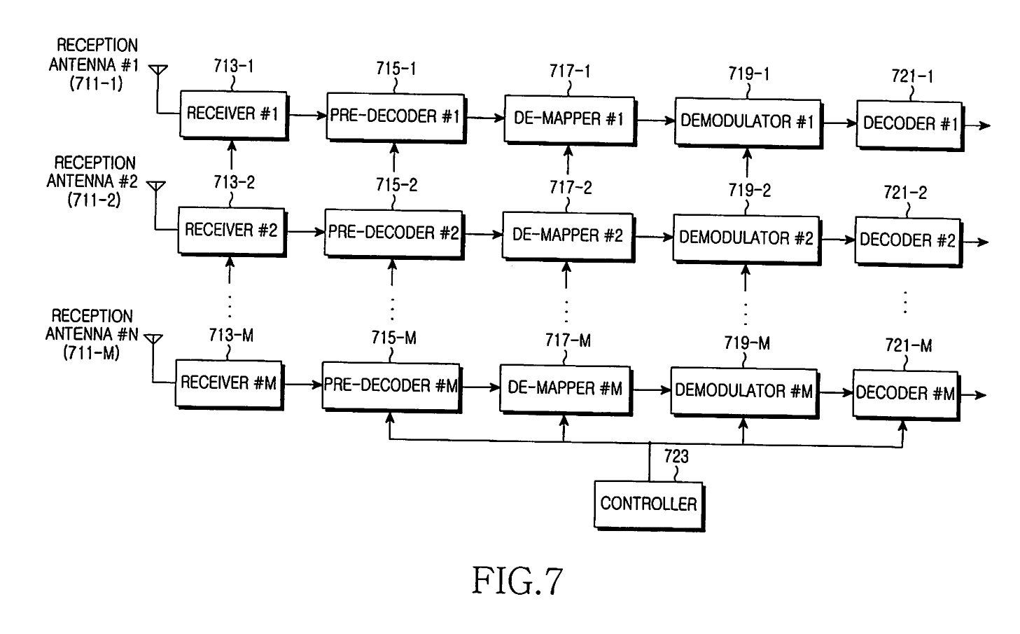

Next, a structure of a signal reception apparatus of a MIMO mobile communication system using an MCW according to an embodiment of the present invention will be described with reference to the block diagram of FIG. 7.

The signal reception apparatus shown in FIG. 7 corresponds to the signal transmission apparatus shown in FIG. 6. The signal reception apparatus includes structures for receiving and processing the N codewords transmitted from the signal transmission apparatus, respectively, which will be described below.

Referring to FIG. 7, the signal reception apparatus includes a plurality of antennas (in this case, for example, a number M reception antennas including reception antenna #1 711-1 to reception antenna #M 711-M), M number of receivers connected to the reception antennas, respectively, which include receiver #1 713-1 to receiver #M 713-M, M number of pre-decoders, which include pre-decoder #1 715-1 to pre-decoder #M 715-M, M number of de-mappers, which include de-mapper #1 717-1 to de-mapper #M 717-M, M number of demodulators, which include demodulator #1 719-1 to demodulator #M 719-M, and M number of decoders, which include decoder #1 721-1 to decoder #M 721-M. Further, the signal reception apparatus includes a controller 723 for controlling operations of pre-decoder #1 715-1 to pre-decoder #M 715-M, de-mapper #1 717-1 to de-mapper #M 717-M, demodulator #1 719-1 to demodulator #M 719-M, and decoder #1 721-1 to decoder #M 721-M.

The signal reception apparatus shown in FIG. 7 is different from the signal reception apparatus using an SCW shown in FIG. 5 only in that the signal reception apparatus of FIG. 7 processes N codewords. However, a basic control operation of the signal reception apparatus, that is, a control operation of the controller 723, is similar to the control operation of the controller 523 illustrated in FIG. 5, so a detailed description thereof is omitted here.

According to the present invention as described above, it is possible to adaptively control the use of a MIMO scheme in consideration of the initial transmission and retransmission in the case of using an HARQ scheme in a MIMO mobile communication system. Therefore, according to the present invention, when there remain parity bits to be transmitted as in initial retransmission, an SM scheme is used as the MIMO scheme, so as to increase a coding gain. When every bit has been transmitted at least once, an STTD scheme is used as the MIMO scheme to enhance the reliability, thereby improving the performance of the entire system.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of transmitting a signal by a signal transmission apparatus in a Multiple Input Multiple Output (MIMO) mobile communication system, the method comprising the steps of:
determining a Hybrid Automatic Repeat reQuest (HARQ) scheme to be used for a transmission signal;
determining a MIMO scheme to be used for the transmission signal in accordance with the determined HARQ scheme; and
transmitting the transmission signal using the determined HARQ scheme and the determined MIMO scheme.

2. The method of claim 1, wherein, in the step of determining a MIMO scheme to be used for the transmission signal in accordance with the determined HARQ scheme, when the determined HARQ scheme is an Incremental Redundancy (IR) scheme, the MIMO scheme to be used for the transmission signal is determined to be a Spatial Multiplexing (SM) scheme.

3. The method of claim 1, wherein, in the step of determining a MIMO scheme to be used for the transmission signal in accordance with the determined HARQ scheme, when the determined HARQ scheme is a Chase Combining (CC) scheme, the MIMO scheme to be used for the transmission signal is determined to be a Space Time Transmit Diversity (STTD) scheme.

4. The method of claim 1, wherein, in the step of determining a MIMO scheme to be used for the transmission signal in accordance with the determined HARQ scheme, when the determined HARQ scheme is a Chase Combining (CC) scheme, the MIMO scheme to be used for the transmission signal is determined to be a Double Space Time Transmit Diversity (DSTTD) scheme.

5. The method of claim 1, further comprising transmitting information on the determined HARQ scheme and the determined MIMO scheme.

6. A signal transmission apparatus in a MIMO mobile communication system, the signal transmission apparatus comprising:
a controller to determine a Hybrid Automatic Repeat reQuest (HARQ) scheme to be used for a transmission signal and determine a Multiple Input Multiple Output (MIMO) scheme to be used for the transmission signal in accordance with the determined HARQ scheme;
an encoder to encode the transmission signal according to the determined HARQ scheme;
a mapper to map a signal output from the encoder according to the determined MIMO scheme; and
a transmitter to transmit a signal output from the mapper.

7. The signal transmission apparatus of claim 6, wherein when the determined HARQ scheme is an Incremental Redundancy (IR) scheme, the controller determines the MIMO scheme to be used for the transmission signal to be a Spatial Multiplexing (SM) scheme.

8. The signal transmission apparatus of claim 6, wherein when the determined HARQ scheme is a Chase Combining (CC) scheme, the controller determines the MIMO scheme to be used for the transmission signal to be a Space Time Transmit Diversity (STTD) scheme.

9. The signal transmission apparatus of claim 6, wherein when the determined HARQ scheme is a Chase Combining (CC) scheme, the controller determines the MIMO scheme to be used for the transmission signal to be a Double Space Time Transmit Diversity (DSTTD) scheme.

10. The signal transmission apparatus of claim 6, wherein the controller determines to transmit information on the determined HARQ scheme and the determined MIMO scheme.

11. A method to transmit a signal by a signal transmission apparatus in a Multiple Input Multiple Output (MIMO) mobile communication system, the method comprising the steps of:
determining a packet format to be used for a transmission signal; and
transmitting the transmission signal using a Hybrid Automatic Repeat reQuest (HARQ) scheme and a MIMO scheme determined in accordance with the determined packet format.

12. The method of claim 11, wherein the packet format, and the HARQ scheme and the MIMO scheme determined in accordance with the packet format are defined by

| | | | | | Number of coded bits | | | | | | | | | | | | | | | | | |
|---|---|---|---|---|---|---|---|---|---|---|---|---|---|---|---|---|---|---|---|---|---|---|
| | | | | | | 2^{nd} | 3^{rd} | 4^{th} | 5^{th} | 6^{th} | | | | | | | | | | | | |
| | | | Total | SC per | 1^{st} tx | tx | tx | tx | tx | tx | Modulation Order | | | | | | Spatial Rate | | | | | |
| | | Mother Code | Coded | spatial | code | code | code | code | code | code | 1^{st} | 2^{nd} | 3^{rd} | 4^{th} | 5^{th} | 6^{th} | 1^{st} | 2^{nd} | 3^{rd} | 4^{th} | 5^{th} | 6^{th} |
| PF | Info bits | bits | bits | Stream | bit | bit | bit | bit | bit | bit | Tx | Tx | Tx | Tx | Tx | Tx | Tx | Tx | Tx | Tx | Tx | Tx |
| 0 | 64 | 0.25 | 256 | 128 | 256 | 256 | 256 | 256 | 256 | 256 | 2 | 2 | 2 | 2 | 2 | 2 | 1 | 1 | 1 | 1 | 1 | 1 |
| 1 | 128 | 0.25 | 512 | 128 | 256 | 256 | 256 | 256 | 256 | 256 | 2 | 2 | 2 | 2 | 2 | 2 | 1 | 1 | 1 | 1 | 1 | 1 |
| 2 | 256 | 0.25 | 1024 | 128 | 1024 | 1024 | 512 | 512 | 256 | 256 | 4 | 4 | 4 | 4 | 2 | 2 | 2 | 2 | 1 | 1 | 1 | 1 |
| 3 | 768 | 0.25 | 3072 | 128 | 2048 | 1204 | 1024 | 512 | 256 | 256 | 4 | 4 | 4 | 4 | 2 | 2 | 4 | 2 | 2 | 1 | 1 | 1 |
| 4 | 1024 | 0.25 | 4096 | 128 | 2048 | 2048 | 1024 | 1024 | 1024 | 1024 | 4 | 4 | 4 | 4 | 4 | 4 | 4 | 4 | 2 | 2 | 2 | 2 |
| 5 | 1536 | 0.25 | 6144 | 128 | 3072 | 3072 | 1024 | 1024 | 512 | 512 | 6 | 6 | 4 | 4 | 4 | 4 | 4 | 4 | 2 | 2 | 1 | 1 |
| 6 | 2560 | 0.25 | 10240 | 128 | 3072 | 3072 | 2048 | 2048 | 512 | 512 | 6 | 6 | 4 | 4 | 4 | 4 | 4 | 4 | 4 | 4 | 1 | 1 |

wherein “PF” indicates a Packet Format index, “info bits” indicates a number of information bits included in an information vector, “Mother Code Rate” indicates a mother code rate applied to the information vector, “Total coded bits” indicates the number of all bits included in the codeword vector, “Soft Code (SC) per spatial stream” indicates the number of all bits included in a Soft CodeWord (SCW) for each spatial stream, the spatial stream refers to a stream transmitted through one transmission antenna, the “Number of coded bits” indicates the number of bits transmitted at each time of transmission, “Modulation Order” indicates a modulation order used at each time of transmission, “spatial rate” indicates a MIMO scheme, a spatial rate having a value of 1 indicates an Space Time Transmit Diversity (STTD) scheme, a spatial rate having a value of 2 indicates a Double (D)-STTD scheme, and a spatial rate having a value of 4 indicates a Spatial Multiplexing (SM) scheme.

13. A signal transmission apparatus in a Multiple Input Multiple Output (MIMO) mobile communication system, the signal transmission apparatus comprising:
a controller to determine a packet format to be used for a transmission signal, and transmit the transmission signal using a Hybrid Automatic Repeat reQuest (HARQ) scheme and a MIMO scheme determined in accordance with the determined packet format;
an encoder to encode the transmission signal according to the determined HARQ scheme;
a mapper to map a signal output from the encoder according to the determined MIMO scheme; and
a transmitter to transmit a signal output from the mapper.

14. The signal transmission apparatus of claim 13, wherein the packet format, and the HARQ scheme and the MIMO scheme determined in accordance with the packet format are defined by

| | | | | | Number of coded bits | | | | | | | | | | | | | | | | | |
|---|---|---|---|---|---|---|---|---|---|---|---|---|---|---|---|---|---|---|---|---|---|---|
| | | | | | | 2^{nd} | 3^{rd} | 4^{th} | 5^{th} | 6^{th} | | | | | | | | | | | | |
| | | | Total | SC per | 1^{st} tx | tx | tx | tx | tx | tx | Modulation Order | | | | | | Spatial Rate | | | | | |
| | | Mother Code | Coded | spatial | code | code | code | code | code | code | 1^{st} | 2^{nd} | 3^{rd} | 4^{th} | 5^{th} | 6^{th} | 1^{st} | 2^{nd} | 3^{rd} | 4^{th} | 5^{th} | 6^{th} |
| PF | Info bits | bits | bits | Stream | bit | bit | bit | bit | bit | bit | Tx | Tx | Tx | Tx | Tx | Tx | Tx | Tx | Tx | Tx | Tx | Tx |
| 0 | 64 | 0.25 | 256 | 128 | 256 | 256 | 256 | 256 | 256 | 256 | 2 | 2 | 2 | 2 | 2 | 2 | 1 | 1 | 1 | 1 | 1 | 1 |
| 1 | 128 | 0.25 | 512 | 128 | 256 | 256 | 256 | 256 | 256 | 256 | 2 | 2 | 2 | 2 | 2 | 2 | 1 | 1 | 1 | 1 | 1 | 1 |
| 2 | 256 | 0.25 | 1024 | 128 | 1024 | 1024 | 512 | 512 | 256 | 256 | 4 | 4 | 4 | 4 | 2 | 2 | 2 | 2 | 1 | 1 | 1 | 1 |
| 3 | 768 | 0.25 | 3072 | 128 | 2048 | 1204 | 1024 | 512 | 256 | 256 | 4 | 4 | 4 | 4 | 2 | 2 | 4 | 2 | 2 | 1 | 1 | 1 |
| 4 | 1024 | 0.25 | 4096 | 128 | 2048 | 2048 | 1024 | 1024 | 1024 | 1024 | 4 | 4 | 4 | 4 | 4 | 4 | 4 | 4 | 2 | 2 | 2 | 2 |
| 5 | 1536 | 0.25 | 6144 | 128 | 3072 | 3072 | 1024 | 1024 | 512 | 512 | 6 | 6 | 4 | 4 | 4 | 4 | 4 | 4 | 2 | 2 | 1 | 1 |
| 6 | 2560 | 0.25 | 10240 | 128 | 3072 | 3072 | 2048 | 2048 | 512 | 512 | 6 | 6 | 4 | 4 | 4 | 4 | 4 | 4 | 4 | 4 | 1 | 1 |

wherein “PF” indicates a packet format index, “info bits” indicates the number of information bits included in an information vector, “Mother Code Rate” indicates a mother code rate applied to the information vector, “Total coded bits” indicates the number of all bits included in the codeword vector, the “Soft Code (SC) per spatial stream” indicates the number of all bits included in a Soft CodeWord (SCW) for each spatial stream, the spatial stream refers to a stream transmitted through one transmission antenna, “Number of coded bits” indicates the number of bits transmitted at each time of transmission, “Modulation Order” indicates a modulation order used at each time of transmission, “spatial rate” indicates a MIMO scheme, a spatial rate having a value of 1 indicates a Space Time Transmit Diversity (STTD) scheme, a spatial rate having a value of 2 indicates a D-STTD scheme, and a spatial rate having a value of 4 indicates an SM scheme.
